(19) United States
(12) Patent Application Publication
(10) Pub. No.: US 2014/0203033 A1
(43) Pub. Date: Jul. 24, 2014

(54) Debris Receiving Receptacle for Attachment to a Work Surface Edge

(71) Applicants: Martyn Schmidt, Mount Prospect, IL (US); Andrew Schmidt, Mount Prospect, IL (US)

(72) Inventors: Martyn Schmidt, Mount Prospect, IL (US); Andrew Schmidt, Mount Prospect, IL (US)

(21) Appl. No.: 13/748,638

(22) Filed: Jan. 24, 2013

(51) Int. Cl. B65F 1/14

(52) U.S. Cl. CPC B65F 1/141
USPC 220/737

(57) ABSTRACT

Disclosed is a receptacle for attachment to the edge of a horizontal work surface, comprising a mounting bracket that is adapted to slideably engage the edge of a work surface, and a waste container that is removably attachable to the bracket. The bracket includes an open center area forming an aperture for accepting and holding the waste container in a working position. The bracket can be attached without the use of specialized mounting hardware. Debris can be moved from the edge of the work surface, and deposited into the receptacle. The device can be installed and removed as needed, which prevents the need for permanent installation.

### BACKGROUND OF THE INVENTION

1. Field of the Invention

The present invention relates to a debris receiving receptacle. More specifically, the present invention pertains to a debris receiving receptacle that is removably attachable to the edge of a work surface for collecting debris that is moved from the work surface and into the receptacle.

Cleaning debris from the edge of a work surface can be a difficult task. Kitchen tables accumulate large amounts of food crumbs, especially in the area where a young child eats. Workshop tables are often covered with sawdust, metal shavings, and other types of remnants from a given project. Draftsmen and artists create large amounts of pencil erasure crumbs and pencil point breaks. Seamstresses cut fabric remnants that are easily spread about the work surface and floor. Work surfaces such as these require constant cleaning in order to maintain an efficient workspace.

Traditional methods of cleaning a work surface include the use of a damp rag. A user moves the debris into a small pile, and then wipes the debris off the edge of the table and into his or her hand. This requires supination of the wrist in order to catch the debris as it moves off the edge of the surface, which can be a difficult task for many users. This often leads to some of the debris missing the user's hand, which then falls to the floor, thereby creating additional work for the user.

Another method of cleaning the surface of the table is by sweeping the debris into a trash receptacle. This requires moving the trash receptacle from its usual location and carrying it to the work surface. A user then lifts the trash receptacle in order to position it just below the edge of the surface with one hand, while sweeping the debris into the receptacle with his or her other hand. This method can be impractical for users who do not have a small trash receptacle that can be easily maneuvered to the edge of a work surface. For example, many households have built in trash receptacles that cannot be moved, or trash receptacles that are too large to be positioned under the edge of the table. Additionally, this method can lead to debris missing the opening of the trash receptacle, as the user attempts to steady the receptacle with one hand while sweeping debris with the other hand.

In addition to small articles of debris, users who prepare foods prior to cooking or assembling into various dishes often have to clean the remnants that are left over from chopping, peeling, and dicing. The preparation processes may require the use of several different ingredients in order to create a single dish. As the user finishes preparing a first ingredient, and then moves on to a second, the remnants of the first ingredient may be spread about the cutting board, floor, or counter, which may limit the available room for preparing the dish. The user then has to stop in order to clean the food remnants from the preparation surface. A common technique for cleaning the chopping block surface is to use the back edge of a knife to move the remnants from the chopping block and into the hand of the user, so he or she can place the remnants into a trash receptacle. This technique, however, leads to many of the remnants falling out of the user's hand and onto the floor, once again creating an additional that requires cleaning.

The present invention overcomes such difficulties associated with cleaning the edge of work surface by providing a quick and efficient means for cleaning debris therefrom. The device includes a mounting bracket and a receptacle that is slideably attachable to the edge of a horizontal work surface, thereby enabling a user to move debris from the work surface into the receptacle. This permits a user to move the debris from a table or cutting board and into a receptacle without having to wipe the debris into his or her hand, or without the use of a garbage receptacle. In this way, the present invention allows a user to maintain a clean work surface by providing a convenient method for quickly discarding debris that accumulates on a horizontal work surface.

2. Description of the Prior Art

Presently, a common way to clean debris from a work surface is with a device that includes bracket and a receptacle into which debris can be placed. A user pushes the debris over the edge of the work surface and into the receptacle. Once full, the receptacle can be removed from the bracket, and emptied. Many of the devices that are currently available or disclosed in the prior art, however, utilize a specialized bracket that is permanently attached to the edge of the work surface with a plurality of fasteners. This makes it impractical to move the bracket and receptacle from one work surface to another. The present invention utilizes a bracket that can be mounted to a wide variety of working surfaces. The bracket is designed to slideably engage the edge of a work surface, which enables a user to quickly install the device, clean the surface, and remove the bracket when not in use.

Other disclosed devices include receptacles that are attachable to a cutting board. This enables a user to cut, chop, or dice various types of food on the cutting board, and collect the debris in the receptacle. The design of these prior art devices, however, require the debris to be contained on the top surface of the cutting board. These devices do not sit flush with the edge of a horizontal work surface, and are therefore not adapted to cleaning debris from the edge thereof. The present invention attaches just below the top of a horizontal work surface, enabling a user to easily wipe, scrape, or push debris from the top of the surface into the receptacle. This simple design provides a user with the ability to clean a variety of horizontal work surfaces without the use of specialized mounting hardware or a cutting board, thereby providing a novel device over those in the prior art.

Northington, U.S. Pat. No. 4,802,595 discloses a trough that attaches to the edge of a draftsman's table for receiving debris that is generated by pencil point breaks and erasures. The trough is attached to the table with a bracket and a fastener, and includes a trough that is removable from the brackets so that debris may be emptied into a waste receptacle. The bracket used in this device requires permanent attachment to a horizontal surface with a fastener, such as a screw or nail, making it impractical to move the device from one horizontal working surface to another. The present invention includes a mounting bracket having a pair of support arms that slideably engage with the edge of a horizontal work surface. The support arms do not require a fastener for attaching to the work surface, thereby enabling the device to be moved from one location to another.

Gregory, U.S. Pat. No. 4,155,310 discloses an eraser crumb catcher, comprising an elongated trough which is supported on a bracket that is secured along an edge of a drafting table. While this device may be useful for collecting pencil point breaks and erasure debris, the trough utilized in this device is substantially different than that of the present invention. The trough of the '310 patent has an inboard side which curves up and out, and then back to terminate above the edge of the working surface, which forms a deflector for the pencil points and erasures to be brushed from the table and into the trough. The present invention includes a trough with an open top, side walls, and a bottom that sits below the edge of a horizontal work surface. This allows the receptacle of the present invention to collect debris of varying size, such as larger food particles that would not otherwise fit between the deflector and the edge of work surface.

Lombardo, U.S. Pat. No. 5,294,194 discloses a catch container for retaining debris wiped from the edge of a work surface that includes a receptacle structure, a mounting bracket, and a sloped surface descending toward the receptacle from the mounting bracket. The device can be mounted under a work surface so that debris displaced from the work surface lands upon the sloped surface. The mounting bracket on this device, however, requires attachment to a drawer that is positioned under the work surface. The bracket of the '194 patent is not designed for attachment directly to the work surface. This limits the locations of attachment, whereas the present invention can be attached to the edge of any work surface, thereby affording convenience to the user when cleaning a surface.

Several patents disclosed in the art claim a cutting board with a debris receiving receptacle attached thereto. Loo, U.S. Pat. No. 6,994,336 discloses a cutting board with a cutting platform and clamp assembly that mounts the cutting board to a counter edge. The cutting board includes a removable receptacle for location over a sink, and hook features for hanging trash bags. Similarly, Lorenz, U.S. Pat. No. 5,996,983 discloses a board and waste container arrangement, wherein the board member is placed on the work surface near the edge thereof. The discharge side of the board member is placed over the edge of the work surface when the board is in the use position. Makowski, U.S. Pat. No. 6,026,972 discloses a debris receptacle for attachment to a cutting board that includes a bag holding frame, a U-shaped backstop, and a leg holding plate. Debris is moved from the cutting board, into the opening of the bag holding frame, and into the bag. The debris receiving receptacles of these devices, however, attach to a cutting board, and are designed for receiving debris from the cutting board. These devices are not adapted to attachment below the edge of a work surface for collecting debris that is moved from the work surface and into the receptacle. The present invention provides a device that can be attached to any work surface, thereby enabling a user to quickly and efficiently clean any debris from therefrom. It does not require the use of a cutting board for cleaning the working surface.

The devices disclosed in the prior art require mounting hardware for the receptacle bracket, a drawer for attachment of the bracket, or the use of a cutting board. The primary function of such devices is to remove debris from one particular location, such as a drafting table or kitchen area. This requires the debris to be in a particular location in order for use of the device. The present invention, however, provides a bracket that can slideably engage with the edge of a work surface. This enables attachment without the use of specialized mounting hardware for the bracket. A user can slide the bracket into position on the edge of the surface, collect the debris on the top of the surface by wiping, sweeping, or scraping, and remove the bracket when cleaning is complete. This, in turn, prevents the need for permanent attachment of the device.

In light of the prior art and the disclosed elements of the present invention, it is submitted that the present invention substantially diverges in design elements from the prior art. Consequently it is clear that that present invention is not described by the art and that a need exists for an improved debris receiving receptacle that attaches to the edge of a work surface. In this regard the instant invention substantially fulfills these needs.

### SUMMARY OF THE INVENTION

In view of the foregoing disadvantages inherent in the known types of debris receiving receptacles now present in the prior art, the present invention provides a new debris receiving receptacle wherein the same can be utilized for providing convenience for the user when cleaning debris from the edge of a work surface.

It is therefore an object of the present invention to provide a new and improved debris receiving receptacle device that has all of the advantages of the prior art and none of the disadvantages.

Another object of the present invention to provide a debris receiving receptacle that attaches to the edge of a work surface.

Another object of the present invention is to provide a debris receiving receptacle that includes a mounting bracket that slideably engages with the edge of a work surface.

A further object of the present invention is to provide a debris receiving receptacle that includes a receptacle that can be removed from the mounting bracket in order to be emptied of the debris contained therein.

Another object of the present invention is to provide a debris receiving receptacle that includes a mounting bracket that attaches to a work surface without the use of mounting hardware.

Yet another object of the present invention is to provide a debris receiving receptacle that can easily be moved from one work surface to another.

A final object of the present invention is to provide a debris receiving receptacle that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the debris receiving receptacle and mounting bracket.

FIG. 2 shows a side view of an alternate embodiment of the mounting bracket, wherein the upper and lower bracket arms are slideably positionable along the vertical connector.

FIG. 3 shows a side view of the present invention attached to a work surface.

FIG. 4 shows a perspective side angle view of the mounting bracket attached to a work surface, with the debris receiving receptacle removed therefrom.

### DETAILED DESCRIPTION OF THE INVENTION

Reference is made herein to the attached drawings. Like reference numerals are used throughout the drawings to depict like or similar elements of the debris receiving receptacle. For the purposes of presenting a brief and clear description of the present invention, the preferred embodiment will be discussed as used for attaching to a work surface. The figures are intended for representative purposes only and should not be considered to be limiting in any respect.

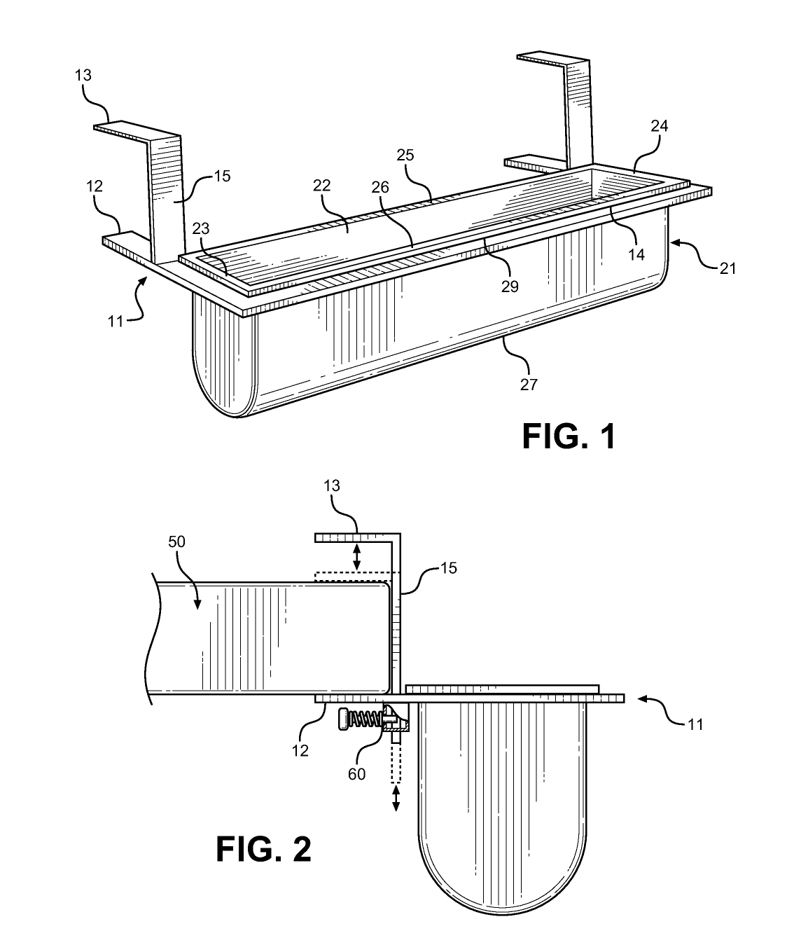

Referring now to FIG. 1, there is shown a perspective view of the present invention, which comprises a mounting bracket 11 and a receptacle 21. The bracket 11 is adapted to slideably engage the edge of a work surface. The bracket 11 utilizes an attachment means that engages the edge of the work surface, and does not require the use of a fastening means, thereby enabling the device to be easily moved from one horizontal work surface to another. The receptacle 21 secures within the bracket 11 and can be removed for emptying of the debris contained therein. The bracket 11 is positioned on the edge of the work surface in such a way that and debris that accumulates on the top of the work surface can be easily moved from the work surface and into the receptacle 21. Once the debris on the work surface has been deposited into the receptacle 21, it can then be removed from the bracket 11 for disposal of the debris contained therein.

The bracket 11 engages the edge of a horizontal work surface in order to support the debris receptacle 21. The bracket 11 is substantially rectangular in shape, and preferably includes an open center area that forms an aperture 14 for accepting and holding the receptacle 21 in a working position. Extending from the rectangle is a pair of upper 12 bracket arms, as well as a pair of lower 13 bracket arms. The upper and lower bracket arms 12, 13 form substantially U-shaped extensions that function to secure the bracket and debris receptacle 21 into position along the edge of the horizontal work surface. Preferably, the bracket arms 12, 13 include a high friction material along the bracket arm and work surface interface to prevent the bracket from inadvertently sliding out of position when installed on the work surface edge. The bracket arms 12, 13 are attached with a vertical connector 15 that provides support for the bracket 11 when it is attached to a work surface.

In an alternate embodiment, the bracket arms include a means of clamping to the edge of the work surface 50. As shown in FIG. 2, for convenience of explanation and not intended to be limiting, the upper and lower bracket arms 13, 12 slide towards each other along the vertical connector 15 so that the brackets arms 13, 12 clamp onto the work surface 50 and lock into position. The bracket 11 can include an aperture into which the vertical connector can slideably attach. Once clamped onto the work surface 50, a locking mechanism can be engaged on the bottom side of the bracket 11. This enables the bracket 11 to be secured to work surfaces of varying thickness.

The receptacle 21 has an open top 22, side walls, 23, 24, 25, and 26, and a bottom 27, thereby forming a rectangular debris receiving receptacle that can be secured within the aperture 14 of the bracket 11. The side walls, 25, 26 forming the length of the receptacle 21 are substantially longer than the side walls 23, 24 forming the width thereof, thereby creating a rectangle. The rectangle shape enables the receptacle 21 to be placed adjacent to the work surface.

The receptacle 21 further includes a lip 29 extending around the outer perimeter of the side walls 23, 24, 25, and 26. The lip 29 provides a contact surface between the receptacle 21 and the aperture 14 of the bracket 11, thereby enabling the receptacle 21 to rest securely within the bracket 11. Preferably, the lip 29 extends to the edge of the bracket 11, completely covering it over. This prevents debris which is moved from the edge of the work surface and into the receptacle 21, from being trapped on the top surface of the bracket 11, between the lip 29 and the work surface.

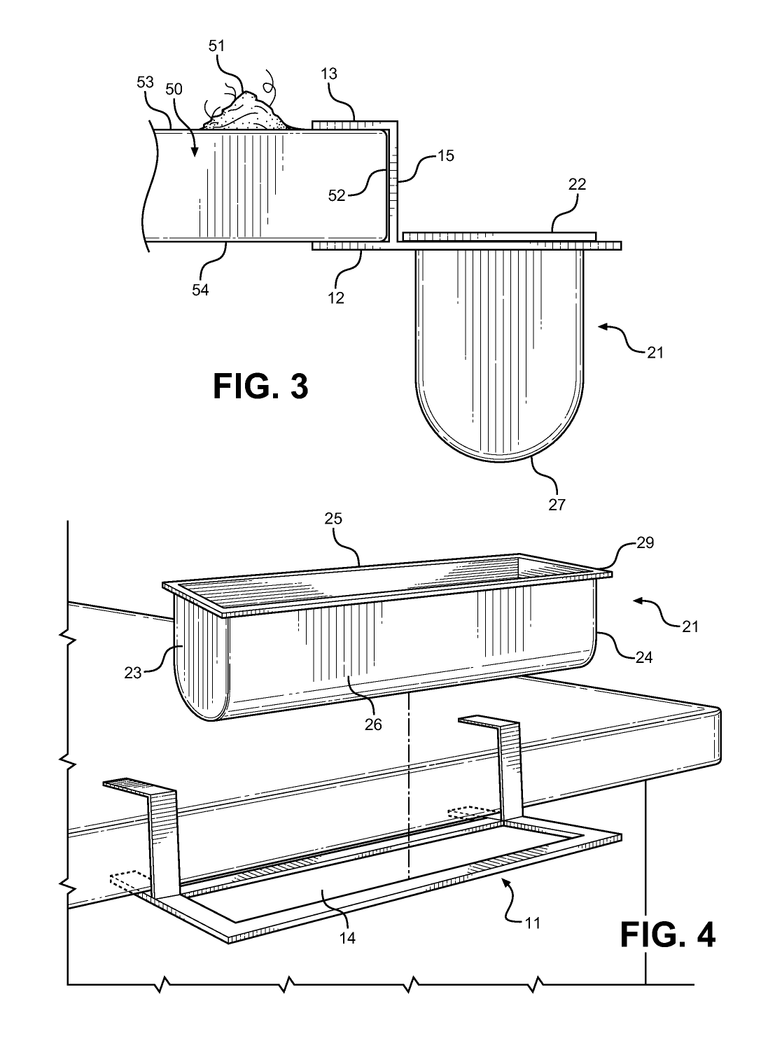

Referring now to FIG. 3, there is shown a side view of the present invention attached to a work surface 53. The upper and lower bracket arms 12, 13 extend from the bracket 21, and form a substantially U-shaped extension. The upper bracket arm 12 secures to the top of the work surface 53, while the lower bracket 13 secures to the bottom of the work surface 54. The distance between the bracket arms 12, 13 is created by the vertical connector, which enables the bracket arms 12, 13 to slideably engage with the edge of the work surface 50. This permits the bracket 11 to remain in position for use on the edge of the work surface 50.

The upper and lower brackets 12, 13 clamp onto the edge of the horizontal work surface 50, which supports the weight of the bracket 11, receptacle 21, and any debris contained therein, such that the device will not inadvertently be moved from the work surface 50. This enables the device to be attached to the edge of a work surface 50 without the use of a specialized bracket that requires permanent attachment to the edge of the working surface. This allows for movement of the device from one work surface to another.

To attach the device, a user positions the upper bracket 13 such that it makes contact with the top of the horizontal work surface 53. The lower brackets 12 will then be positioned under the bottom of the work surface 54. A user can then slide the bracket 11 towards the work surface 50 until the vertical connector 15 abuts the vertical face 52 of the work surface 50. Once the vertical connector 15 makes contact with the vertical face 52, the lip 29 of the receptacle 21 will also be in contact with the vertical face 52. This prevents any debris 51 moved from the work surface 50 from sliding between the work surface 50 and the bracket 11.

When debris 51 accumulates on the work surface 50, the debris 51 can be moved from the work surface 50 and into the receptacle 21. A user can move the debris 51 towards the edge of the work surface 50, in a wiping, pushing, or scraping motion, which propels the debris 51 off the edge thereof. Gravity then causes the debris 51 to fall towards the receptacle 21, which is positioned under the edge of the work surface 50. As debris is pushed from the surface 50, it travels over the edge of the work surface 50, and down the vertical face 52. The debris 51 then enters into the open top 22 of the receptacle 21, where it continues to fall until it makes contact with the bottom 27 of the receptacle 21.

The speed at which the user moves the debris 51 from the work surface 50 and into the receptacle 21 can vary the angle at which the debris 51 falls. If the user wipes the debris 51 slowly, it can fall at a nearly vertical angle, and come to rest on the lip 29 of the receptacle. Because the lip 29 extends over the top of the bracket 11, the debris 51 will make contact with the lip 29, and then fall into the receptacle 21. This prevents debris 51 from being trapped between the vertical face 52 of the work surface 50 and the bracket 11. Any debris 51 that remains on the top of the lip 29 can simply be wiped into the receptacle 21.

Referring now to FIG. 4, there is shown a perspective side angle view of the mounting bracket attached to a work surface, with the debris receiving receptacle removed therefrom. The receptacle 21 can be removed from the bracket 11, thereby allowing the debris contained therein to be disposed of without requiring removal of the bracket 11 from the work surface 50. The lip 29 of the receptacle 21 engages with the bracket 11, which holds the receptacle 21 in position. The side walls, 23, 24, 25, and 26 of the receptacle 21 are designed to fit within the aperture 14 of the bracket 11, with the lip 29 resting thereon. This design prevents the receptacle 21 from falling through the aperture 14, yet affords ease of installation and removal.

The design of the bracket 11 and receptacle 21 enable a user to quickly empty the contents of the receptacle 21 when it is filled with debris. The receptacle 21 can be quickly removed from the bracket 11 and carried to a waste can to be emptied. A user can grasp the receptacle 21 by the side walls 23, 24, 25, and 26 in order to raise it from the bracket 11. Alternately, the user can grasp the lip 29 in order to raise it from the bracket 11. The receptacle 11 can then lift vertically out of the bracket 11 for emptying. Once the receptacle 11 has been emptied, it can be positioned back inside the aperture 14 for use.

The receptacle 21 may be constructed of any suitable material that is able to contain the debris placed therein. Materials such as PVC, ABS plastic, stainless steel, or aluminum are contemplated. The use of such materials enables the present invention to contain both solid and liquid debris, and additionally allows for ease of cleaning the interior of the receptacle 21. Likewise, the bracket 11 may be constructed of any material or form that can attach to a work surface 50 and that holds the receptacle 11 in place.

Overall, the present invention provides users with a quick and efficient means for cleaning debris from the edge of a work surface. The device can be slideably engaged with the edge of a work surface without requiring specialized mounting hardware. Any debris that accumulates on the top of a work surface can be quickly and efficiently deposited into the receptacle. The device can be installed and removed as needed, which prevents the need for permanent installation. This enables a user to perform a desired task, install the receptacle and bracket on the edge of a table or cutting board, deposit the debris into the receptacle, and remove the bracket when complete.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A debris receiving receptacle, comprising:
a mounting bracket, said mounting bracket having a waste container aperture and extensions being adapted to slideably engage an edge of a work surface;
a waste container having an open top, side walls, and a bottom, said waste container adapted to be removably supported within said mounting bracket aperture.

2) The device of claim 1, wherein said mounting bracket further comprises a pair of U-shaped extensions each formed of an upper and lower bracket arm connected by a vertical connector that are adapted to receive said edge of a work surface.

3) The device of claim 1, wherein said U-shaped extensions further comprise a high friction material to prevent slippage along said work surface.

4) The device of claim 1, wherein said receptacle further comprises a horizontal lip extending from said side wall perimeter to provide a contact surface between said receptacle and bracket aperture.

5) The device of claim 1, wherein said upper and lower bracket arms of said U-shaped extensions are further vertically adjustable, thereby changing said U-shape height for different thickness work surfaces.

6) The device of claim 5, wherein said adjustable bracket arms are further lockable in a static position.

7) A debris receiving receptacle, comprising:
a mounting bracket, said mounting bracket having a waste container aperture and a pair of U-shaped extensions each formed of an upper and lower bracket arm connected by a vertical connector that are adapted to receive said edge of a work surface;
a waste container having an open top, side walls, and a bottom, said waste container adapted to be removably supported within said mounting bracket aperture via a horizontal lip extending from said side wall perimeter, which provides a contact surface between said receptacle and bracket aperture.

8) The device of claim 7, wherein said U-shaped extensions further comprise a high friction material to prevent slippage along said work surface.

9) The device of claim 1, wherein said upper and lower bracket arms of said U-shaped extensions are further vertically adjustable, thereby changing said U-shape height for different thickness work surfaces.

10) The device of claim 9, wherein said adjustable bracket arms are further lockable in a static position.
